(19) United States
(12) Patent Application Publication
(10) Pub. No.: US 2026/0134236 A1
(43) Pub. Date: May 14, 2026

(54) INACTIVITY PROCEDURES FOR INTERMEDIATE NODES CONNECTING A RADIO TAG TO A READER DEVICE

(71) Applicant: Fraunhofer-Gesellschaft zur Foerderung der angewandten Forschung e.V., Munich (DE)

(72) Inventors: Thomas FEHRENBACH, Berlin (DE); Baris GOEKTEPE, Berlin (DE); Thomas WIRTH, Berlin (DE); Thomas SCHIERL, Berlin (DE); Cornelius HELLGE, Berlin (DE); Thomas WIEGAND, Berlin (DE); Alvaro LÓPEZ RAVENTÓS, Berlin (DE); Buket TORUN, Berlin (DE)

(21) Appl. No.: 19/382,951

(22) Filed: Nov. 7, 2025

(30) Foreign Application Priority Data
Nov. 8, 2024 (EP) 24211907.1

(51) Int. Cl. G06K 7/10

(52) U.S. Cl. CPC G06K 7/10019; G06K 7/10198

(57) ABSTRACT

A reader device for communicating with at least one radio tag of a plurality of radio tags is described. The reader device is connectable to a radio access network, RAN, entity of a wireless communication system and to one or more or all of the plurality of radio tags. Responsive to one or more conditions, the reader device operates in accordance with a radio tag mode, e.g. an A-IoT mode, in which a data transfer between the radio device and the at least one radio tag is enabled.

### CROSS-REFERENCE TO RELATED APPLICATION

This application claims priority from European Patent Application No. EP 24 211 907.1, filed on Nov. 8, 2024, and is incorporated herein in its entirety by reference.

The present invention relates to the field of radio tags and reader devices for wireless communication systems or networks, more specifically to low complexity radio tags employing low-power communication techniques. Embodiments of the present invention concern enhancements of inactivity procedures for intermediate nodes connecting one or more low complexity radio devices or radio tags to a reader device.

### BACKGROUND OF THE INVENTION

Low complexity radio devices or radio tags using backscattered communication techniques for transmitting a signal are well-known, see, e.g., Jin-Ping Niu, Geoffrey Ye Li in “An Overview on Backscatter Communications”, Journal of Communications and Information Networks, Vol. 4, No. 2, June 2019. One example of low complexity radio devices using backscatter communication techniques are radio frequency identification, RFID, tags. An RFID tag identification is performed through a series of interactions between an RFID reader and an RFID tag. Radio frequency signals are used to communicate and exchange data between the RFID reader and the RFID tag. An RFID tag, which has a unique identification, ID, responds to a query of an RFID reader by transmitting information stored in the RFID tag. This process, also known as inventorying, uses anti-collision algorithms, like the slotted ALOHA protocol, to manage multiple tags within a RFID reader's field or communication range and for avoiding signal interferences. The RFID tags are typically identified individually, with the RFID reader sequentially querying each RFID tag to compile a list of all RFID tags within the RFID reader's communication range. The actual identification process varies dependent on the type of RFID tags in use, which may be passive, semi-passive or active. Passive RFID tags, which are most common due to their cost-effectiveness, rely entirely on the RFID reader's signal for power. These RFID tags backscatter the received signal to transmit data stored in the RFID tag. Semi-passive RFID tags have an internal battery to power the circuits of the RFID tag thereby improving the read range and the data transmission reliability. Active RFID tags, which are equipped with an own power source, may communicate over greater distances and may store more data, making them suitable for applications requiring more coverage.

Another technology using low complexity devices using backscatter communication techniques for low power consumption involve Internet-of-Thing, IoT, devices in accordance with the 3GPP standard. Such IoT devices are currently further developed so as to provide ultra-low complexity devices with ultra-low power consumption, especially for very low end IoT applications. Such further developed IoT devices, like Ambient IoT devices, are well-below the existing 3GPP technologies, e.g., narrowband IoT (NB-IoT) devices, enhanced Machine Type Communication (eMTC) devices, or devices with reduce capabilities (RedCap devices). The further development of IoT devices towards ultra-low complexity devices with ultra-low power consumption is not driven by a desire to replace existing low-power wide area, LPWA, systems, rather, it is driven by the desire to provide a missing piece of ultra-low complexity and ultra-low power devices in the 3GPP system such that other 3GPP devices, like a user equipment or user device, UE, a base station, BS, or any New Generation Radio Access Network (NG-RAN) node may directly or indirectly connect with such devices or may be used for controlling or managing a whole system including thousands of low complexity devices like Ambient IoT devices. The ultra-low complexity IoT devices having ultra-low power consumption may be classified in the following power classes:
(1) The device has a peak power consumption of about 1 μW and includes an energy storage. The device has an initial sampling frequency offset, SFO, of up to 10× ppm. The device provides neither a downlink, DL, amplification nor an uplink, UL, amplification. An uplink transmission of the device is backscattered on a carrier wave provided by an external source.
(2) The device has a peak power consumption less than a few hundred μW and includes an energy storage. The device has an initial sampling frequency offset, SFO, of up to 10× ppm. The device provides a downlink, DL, amplification and/or an uplink, UL, amplification. An UL transmission may be generated internally by the device or may be backscattered on a carrier wave provided by an external source.

A maximum communication distance of such devices, when being deployed indoors, is between 10 m and 50 m. Different topologies are supported, e.g., topology 1 and/or topology 2. In detail, topology 1 refers to a direct communication between the reader and the device, while topology 2 involves the use of an intermediate node. In the latter, a user equipment, UE, may be provided in such topologies as an intermediate note which is under control of the 3GPP network for supporting the IoT devices with low complexity and low power consumption which may have no Radio Resource Control, RRC, states, provide for no mobility support, i.e., do not support any cell selection and/or cell reselection functions, and do not have any feedback capabilities, like hybrid acknowledge request, HHARQ, and/or acknowledge request, ARQ, capabilities.

Like in RFID systems, also in the above-described IoT systems, each IoT device is assigned with a unique identifier, ID, and/or a group-ID for allowing the identification and tracking of a single IoT device or of a set of IoT devices.

The above-described RFID systems and IoT systems focus on an individual tag identification using, for example, a unique identifier or individual tag identification, which may be used for single devices or for a group of devices. However, such systems are not capable to handle scenarios in which the devices belong to different groups simultaneously.

For instance, a supply chain item may belong to multiple groups depending on different aspects, like product type (e.g., fragile, electronic, perishable), storage requirements (e.g., refrigerated, climate-controlled), and shipment details (e.g., batch number, shipping method). In such a context, conventional RFID/IoT systems which support single tag/single group operations, lack mechanisms for managing overlapping group memberships. Such limitations hinder an efficient management and tracking across multiple functional categories leading to multiple constraints. For example, the rigid structure of single group-ID indications reduces the system flexibility and makes it difficult to adapt to changing environments where items or individuals frequently shift between different groups. Also the lacking capacity to manage overlapping groups makes resource allocation and tracking cumbersome and difficult and leads to undesired delays.

Further, conventional systems do not inherently support the requirements for a group reconfiguration responsive to changing operational needs which, in turn, restricts the ability of conventional systems to adapt to real-time conditions, such as fluctuating inventory levels, varying environment conditions or shifting operational properties. Also the lack of mechanisms for managing group-specific commands and responses increases a complexity in applications that require dynamic grouping.

Typically, radio tag data is lightweight, i.e., often consisting only of hundreds of bits per transmission. However, there are scenarios involving hundreds of radio tags which may be inventoried or triggered to send data simultaneously. For example, in a smart grid for electricity networks several hundred sensors may be activated to report environmental parameters all at once. This kind of simultaneous communication may create challenges, especially in a topology where an intermediate node serves as a relay for data and signaling between the radio tags and a reader device, like a base station in a wireless communication network. In such a scenario, the intermediate node has the transition to a connected state, like the RRC_CONNECTED state, for accessing network resources and for facilitating the relay functionality. However, maintaining the intermediate node, like a user equipment, UE of a wireless communication system, in the RRC_CONNECTED state for long periods of time may result in a significant energy consumption at the intermediate node. This becomes even more severe if multiple radio tags need to transmit high amounts of data, for example several hundred bytes, which requires a segmentation of the overall transmission into multiple transmission segments. Further, from a perspective of the radio tag, in such a scenario long waiting times may be experienced as well as an increased number of re-access attempts since the elevated number of contending radio tags may lead to an increased collision rate. This is may even be further exacerbated if the intermediate node moves out-of-coverage of the reader device which, potentially, leads to a suspension of any data transmission and requiring a restart.

For example, when considering a wireless communication system for a cellular communication in accordance with the 3GPP standard, a user equipment, UE, may operate in different radio resource control, RRC, states to manage its connection with a network. The RRC states include the RRC_CONNECTED state, the RRC_INACTIVE state, and the RRC_IDLE state. These RRC states are illustrated in FIG. 1, and each of these RRC states serves a distinct role in the communication process:
RRC_IDLE: In this state, the UE is not actively connected to the network, and no radio resources are allocated. The UE is, however, able to monitor paging messages from the gNB, allowing it to be alerted if there is incoming data or if the network needs to reach it. RRC_IDLE is power-efficient as the UE only intermittently checks for paging, making it suitable when the UE does not need constant connectivity, such as during periods of inactivity or low data transmission. It also allows the UE to perform cell reselection, ensuring it stays in range of the strongest signal when moving.
RRC_INACTIVE: This state provides a middle ground between RRC_IDLE and RRC_CONNECTED. The UE retains its radio context (such as the last connected gNB) but does not actively consume radio resources, allowing for faster transitions back to RRC_CONNECTED without the need for a full connection setup. This makes RRC_INACTIVE ideal for scenarios where the UE needs to switch between periods of inactivity and quick bursts of data transmission, reducing signaling overhead and power consumption. It also enables the UE to maintain a connection while moving between gNBs, supporting features like mobility and connection continuity without requiring constant active connection maintenance.
RRC_CONNECTED: In this state, the UE has an active connection with the gNB, allowing it to transmit and receive data with dedicated radio resources. RRC_CONNECTED is used when the UE is engaged in data transmission activities, such as video streaming, voice calls, or real-time data communication. While this state allows high data communications, it also consumes more power as the UE has to constantly maintain the active connection, making it less ideal for low-power devices or when data transmission is sporadic.

For a communication between a radio tag and a wireless communication system, like a 3GPP system or a WiFi system or an RFID system, a topology as depicted in FIG. 2 may be employed. FIG. 2 illustrates a topology for a communication between a radio tag, like an Ambient IoT device, and a wireless communication system or network operating in accordance with the 3GPP standard. The radio tag or Ambient IoT device 100 communicates via an intermediate node 200 with a base station 300. The intermediate node 200, e.g., a UE of the wireless communication network, is connected to the base station 200 via the Uu link, and a communication or data transfer between the base station 300 and the intermediate node 200 is in accordance with the communication protocol used by the wireless communication network. The radio tag or Ambient IoT device 100 communicates with the intermediate node 200, and the communication between the radio tag 100 and the intermediate node 200 involves a data transmission, for example a data transmission of data gathered by the Ambient IoT device 100 and to be forwarded to the wireless communication network. The communication also comprises a signaling, for example a signaling by the intermediate node 200 for querying the Ambient IoT device 100 for data. As is depicted in FIG. 2, the intermediate node 200 acts as a relay providing for a data transmission and a signaling between the base station 300 and the radio tag or Ambient IoT device 100. Thus, with this configuration the network, more specifically, the intermediate node, assumes the role of the reader device. The intermediate node is controlled by the wireless communication network and, therefore, has to remain in an RRC_CONNECTED state. Stated differently, for providing the reader functionality, the intermediate node 200 has to remain in the RRC_CONNECTED state. If the intermediate node 300 enters into the RRC_INACTIVE state or into the RRC_IDLE state, the communication is paused or temporarily suspended. Pausing or temporarily suspending the communication means that the intermediate node 200 neither communicates with the base station 300 nor with the radio tag 100. This is because in the non-connected states the intermediate node 300 no longer has active access to the network resources and, therefore, cannot perform the necessary data transmission and reception functions required for relaying information between the base station 300 and the radio tag 100. Stated differently, when the intermediate node 200 is not in the connected state, the relay process is interrupted until the intermediate node or reader device 200 returns to the RRC_CONNECTED state.

It is noted that the information in the above section is only for enhancing the understanding of the background of the present invention and, therefore, it may contain information that does not form conventional technology that is already known to a person of ordinary skill in the art.

Starting from the above, there may a need for enhancing inactivity procedures for intermediate nodes connecting one or more low complexity radio tags or devices, for example RFID tags or low complexity IoT devices, to a reader device.

As discussed above, conventional approaches require an intermediate node to remain connected to the wireless communication network, like a RAN entity thereof, so as to avoid any pausing or temporary suspension of a communication between the radio tag and the wireless communication network. This dependency on the connected state limits the energy efficiency of the intermediate or relay node as it has to remain continuously connected to the network for maintaining the communication. This presents certain challenges, for example, in scenarios where an extended connectivity is required, for example when the intermediate node loses connection to the RAN entity of the wireless communication network and enters into a non-connected state, like an RRC_IDLE state or an state. This loss of connection may be due to a drop in signal quality on the channel between the intermediate node and the RAN entity or due to the intermediate node becoming out-of-coverage. For example, the intermediate node may be out-of-coverage in situations in which a mobile intermediate node moves out of the coverage area of the base station or RAN entity which serves the intermediate node. In other scenarios, a RAN entity may, for example, temporarily, not be in a position for supporting the intermediate node with regard to the resource allocation which is also considered an out-of-coverage state.

The present application addresses the problems encountered in conventional technology approaches by providing a reader device that is connected between a RAN entity of a wireless communication network and one or more radio tags, like one or more Ambient IoT devices or RFID tags, and that is capable to preform only the necessary operations for a communication with the radio tag which is less energy consuming than the processes regarding a connection to the RAN entity. For example, the reader device may maintain a communication with the one or more radio tags even when the intermediate node is in a non-connected state with regard to the RAN entity. This allows the intermediate node to save energy without pausing or temporarily suspending the communication as it would be case when entering into a non-connected state in accordance with conventional approaches. Thus, in accordance with embodiments, the operation of the intermediate node no longer depends on being in a connected state with regard to the wireless communication network.

### SUMMARY

An embodiment may have a reader device for communicating with at least one radio tag of a plurality of radio tags, wherein the reader device is connectable to or is deployed within a radio access network, RAN, entity of a wireless communication system and to one or more or all of the plurality of radio tags, wherein, responsive to one or more conditions, the reader device is to operate in accordance with a radio tag mode, e.g. an A-IoT mode, in which a data transfer between the radio device and the at least one radio tag is enabled.

Another embodiment may have a radio tag for communicating with a reader device, which serves a plurality of radio tags and is gNB-reader comprising an A-IoT reader that is deployed within a gNB of a wireless communication system, wherein the radio tag comprises an A-IoT device which communicates with the A-IoT reader using an A-IoT radio interface, the A-IoT radio interface supporting one or more A-IoT procedures, the A-IoT procedure comprising an A-IoT paging, an A-IoT access procedure and a D2R data transmission performed during the A-IoT procedure, and wherein the D2R transmission by the radio tag comprises a D2R upper layer data transfer message for a segment of the data transmission which includes:
a SDU length field,
a data SDU field which is set to include the segment, and
a more data indication field, wherein the more data indication field is set to 0, if the segment is the last segment of an original upper layer data SDU, and wherein the more data indication field is set to 1, if the segment is not the last segment of the original upper layer data SDU.

Another embodiment may have a method for operating a reader device for communicating with at least one radio tag of a plurality of radio tags, wherein the reader device is connectable to or is deployed within a radio access network, RAN, entity of a wireless communication system and to one or more or all of the plurality of radio tags, the method comprising: responsive to one or more conditions, operating the reader device in accordance with a radio tag mode, e.g. an A-IoT mode, in which a data transfer between the radio device and the at least one radio tag is enabled.

Embodiments of the present invention may be implemented in a wireless communication system including RAN entities, like base stations, reader devices, like UEs or mobile terminals, and radio tags, like A-IoT devices or RFID tags. FIG. 3 is a schematic representation of a wireless communication system including a radio tag 100, a reader device or intermediate node 200, like a UE, and a RAN entity 300, like a base station. The radio tag 100 and the UE 200 may communicate via a wireless communication link or channel 302, and the UE 200 and the base station 300 may communicate via a wireless communication link or channel 304, like a Uu link. The radio tag 100 may include one or more antennas ANT_{Tag} or an antenna array having a plurality of antenna elements, a signal processor or chip 100a and a transceiver 100b, coupled with each other. The UE 200 includes one or more antennas ANT_{UE} or an antenna array having a plurality of antennas, a signal processor 200a, and a transceiver 200b coupled with each other. The base station 300 may include one or more antennas ANT_{BS} or an antenna array having a plurality of antenna elements, a signal processor 300a and a transceiver 300b, coupled with each other. The system or network of FIG. 3, the one or more radio tags 100 of FIG. 3, the one or more UEs 200 of FIG. 3, and one or more the base stations 300 of FIG. 3 may operate in accordance with the inventive teachings described herein.

The present invention provides a reader device for communicating with at least one radio tag of a plurality of radio tags,
wherein the reader device is connectable to or is deployed within a radio access network, RAN, entity of a wireless communication system and to one or more or all of the plurality of radio tags,
wherein, responsive to one or more conditions, the reader device is to operate in accordance with a radio tag mode, e.g. an A-IoT mode, in which a data transfer between the radio device and the at least one radio tag is enabled.

In accordance with embodiments, for communicating with at least one radio tag of a plurality of radio tags, like one or more A-IoT devices, the reader device comprises a gNB-reader which is an A-IoT reader that is deployed within the RAN entity, like a gNB.

In accordance with embodiments, the A-IoT reader deployed within the gNB communicates with the one or more A-IoT devices using an A-IoT radio interface, the A-IoT radio interface supporting one or more A-IoT procedures, the A-IoT procedure comprising an A-IoT paging, an A-IoT access procedure and a D2R data transmission performed during the A-IoT procedure.

In accordance with embodiments, responsive to the one or more conditions, the A-IoT reader operates in accordance with the A-IoT radio interface for enabling the data transfer between the one or more A-IoT devices and the A-IoT reader.

In accordance with embodiments, the one or more conditions for operating in accordance with the A-IoT radio interface comprises a certain communication with the at least one radio tag or A-IoT device, like an A-IoT paging, an A-IoT access procedure and a D2R data transmission performed during the A-IoT procedure.

In accordance with embodiments, the one or more conditions for operating in accordance with the A-IoT radio interface comprises an A-IoT procedure to be performed by the reader device over the A-IoT radio interface which includes an A-IoT paging, an A-IoT access procedure and a D2R data transmission.

In accordance with embodiments, the one or more conditions for operating in accordance with the A-IoT radio interface comprises an inventory or command request message sent by an A-IoT CN node for initiating the A-IoT procedure over the A-IoT radio interface to perform an A-IoT paging, an A-IoT access procedure and a D2R data transmission.

In accordance with embodiments, the reader device receives the D2R data transmission, the D2R transmission comprising a D2R upper layer data transfer message for a segment of the data transmission which includes
a SDU length field,
a data SDU field which is set to include the segment, and
a more data indication field,

In accordance with embodiments, the more data indication field is set to
0, if the segment is the last segment of an original upper layer data SDU,
1, if the segment is not the last segment of the original upper layer data SDU.

In accordance with embodiments, when being in the radio tag mode, the reader device is in a state, e.g. RRC_IDLE or RRC_INACTIVE or out of coverage, in which no data transfer is enabled between the reader device and the RAN entity, e.g. via a Uu link.

In accordance with embodiments, the radio tag is a wireless device capable to transmit and/or receive radio frequency signals with one or more reader devices.

In accordance with embodiments, the radio tag is a wireless device capable to receive radio frequency signals from one or more reader devices and to transmit using backscatter communication.

In accordance with embodiments, the one or more conditions comprise one or more of the following:
a certain status of the reader device,
a certain status of the wireless communication system,
a certain communication with the at least one radio tag,
a certain status of the at least one or more radio tags, e.g., a radio tag being in an active state,
a certain radio tag operation to be performed by the reader device,
a certain signaling, e.g., from the RAN entity, causing the reader device to operate according to the radio tag mode.

In accordance with embodiments, the certain status of the reader device comprises one or more of the following:
an operating status of the reader device,
a connection status of the reader device with the RAN entity,
a geo-location of the reader device, e.g., the reader device being within a configured or pre-configured communication range and/or distance to the one or more radio tags.

In accordance with embodiments, the operating status of the reader device comprises a low power reader state in which the reader device is to check, e.g. periodically, for radio tags and to enter an active reader state when one or more radio tags are present.

In accordance with embodiments, the reader device is to enter the active reader state only in case the reader device is within a range of
at least one radio tag,
n radio tags, e.g., n>1,
a group of radio tags, e.g., with respect to a group identifier,
a certain type of radio tags, e.g., only in case certain type of radio tags are within reach of the reader device.

In accordance with embodiments, the operating status of the reader device comprises one or more of the following:
an energy level at the reader device, wherein the reader device operates in the radio tag mode if the battery level or an amount of energy harvested over a certain period drops below a configured or preconfigured threshold,
an available memory storage level, wherein the reader device is to operate in the radio tag mode if an available memory storage is above a configured or preconfigured threshold,
an external signal, e.g., a presence detection, a movement, a detection of a 3GPP or a non-3GPP wireless signal,
one or more environmental parameters being above or below a certain threshold.

In accordance with embodiments, the connection status of the reader device comprises one or more of:
a non-connected state, like an idle state or an inactive state, which transfer of data collected from the radio tag from the reader device to the RAN entity is possible, a connection with a radio access network system does not support A-IoT,
a device-to-device state, e.g., the reader device enters a device-to-device state where no connectivity via a Uu link is allowed, e.g., mode 2 in NR,
an out-of-coverage state.

In accordance with embodiments, in the non-connected state, certain messages m be transmitted, e.g., the certain messages may include one or more of the following:
a wake-up signal, WUS,
a synchronization signal, e.g., PSS and/or SSS,
a broadcast message,
a control message, e.g., PHY and/or MAC-CE and or RRC,
a start indicator.

In accordance with embodiments, the reader device is in the out-of-coverage state responsive to one or more of the following:
a radio link failure, RLF,
a handover, HO, or conditional handover, CHO, failure,
a hard handover, e.g., a serving cell connection is released before the candidate cell connection is engaged, Break-Before-Make (BBM),
a ping pong effect detection, e.g., a given number of transitions between connectivity states exceeds a configured or preconfigured threshold within a time interval,
not receiving any resource allocation configuration or assistance from the RAN entity.

In accordance with embodiments, when being in the out-of-coverage state, the reader device is to
retain allocated resources for a communication with the at least one radio tag for at least a configured or preconfigured time, or
release allocated resources for a communication with the at least one radio tag, or
release allocated resources for a communication with the at least one radio tag and use a configured or preconfigured set of resources or a resource pool for a communication with the at least one radio tag, or use a configured or preconfigured set of resources or a resource pool for a communication with the at least one radio tag,
receive a set of preferred and/or non-preferred resources from another device, e.g., via a direct interface or using inter-UE coordination information, IuC, messages.

In accordance with embodiments, the other device comprises one or more of the following:
a user equipment, UE,
a reader device,
an IoT device,
a base station, e.g., a gNB,
a non-terrestrial network, NTN or drone,
a radio tag.

In accordance with embodiments,
when being in the out-of-coverage state, the reader device is to start a configured or preconfigured timer, and
following the lapse of the configured or preconfigured timer, the reader device is to perform one or more of the following:
stop a communication with the at least one radio tag,
discard any stored data from the at least one radio tag,
continue a communication with the at least one radio tag,
start or activate a communication with the radio network, e.g., via Uu or via a direct communication interface with a RAN node,
change to a discontinuous reception mode, DRX, or eDRX,
start a cell search,
perform a random access, PRACH, to a base station
release currently used resources for transmission
use a pre-configured set of resources to start or continue a communication, e.g., an exceptional pool of resources.

In accordance with embodiments, the certain status of the wireless communication system comprises one or more of the following:
a signal quality on a channel between the reader device and the RAN entity drops below a configured or preconfigured threshold, e.g., one or more of a Radio Signal Strength Indicator, RSSI, a Signal to Noise Ratio, SNR, a Signal to Interference plus Noise Ratio, SINR, or a Reference Signal Received Power, RSRP, falling below a certain level,
a specific time, e.g., during times, like peak hours, when a load in the wireless communication system load is above a configured or preconfigured threshold, or during a quiet period, e.g., in case there is less data traffic in the radio access network, RAN.
a specific location or geographical area in which the reader device is located, e.g., a restricted area, or a geographic boundary that limits the communication capabilities, e.g., a minimum required communication range requirement,
a specific scenario characteristic, e.g., dependent on the reader device being located indoor, outdoor, in an Urban Micro Cell, UMi, in an Urban Macro Cell, UMa, the reader device is or is not operated in the radio tag mode,
a mobility characteristic, e.g.,
   in case the reader device is moving:
      the device may release the assigned resources when detecting mobility or moving further than a certain distance from its original position.
   in case the reader device is static:
      the device may continue using the assigned resources for a pre-configured amount of time before releasing them.

In accordance with embodiments, the certain communication with the at least one radio tag comprises:
a backscattering indicating a status from the device, e.g. a scheduling request from the tag,
a status indication from the tag, indicating e.g. a certain status of the device such as a sensor value or power state,
a signaling of a certain tag ID and/or group ID,
a feedback indication from the tag, e.g. ARQ or HARQ feedback, scheduling request or initial access request,
receiving only a first part of a data transmission from the at least one radio tag which indicates, e.g., a second part of a data transmission.
a transmission while in a connected state in which a transfer of data collected from the radio tag from the reader device to the RAN entity is possible.

In accordance with embodiments, a transmission from the at least one radio tag indicates explicitly or implicitly one or more of the following:
a further part of the data transmission,
a first part of the data transmission,
a last part of the data transmission,
a number of further parts of the data transmission,
an availability of other data transmissions,
a size of the data transmission,
a remaining size of the data transmission,
a number of other data transmissions,
one or more further control data transmissions, e.g., a CRC checksum, device or group IDs, power state.

In accordance with embodiments, the reader device is to determine the transmission to be the initial part of the data transmission
implicitly from an absence of an end of transmission signaling in the initial part of the data transmission, like an end-bit, or
from a presence of a signaling in the initial part of the data transmission indicating the presence of one or more additional parts of the data transmission.

In accordance with embodiments, the reader is to schedule the at least one radio tag with a reserved set of resources for transmitting one or more additional parts of the data transmission while operating in the radio tag mode.

In accordance with embodiments, the certain radio tag operation to be performed by the reader device comprises:
one or more non-time critical operations, e.g., a routinary inventory scan through the plurality of radio tags,
performing one or more commands for one or some or all of the plurality of radio tags following a reading of data from the at least one radio tag in a connected state in which a data transfer between the reader device and the RAN entity is possible,
a reading of data from the at least one radio tag which has a priority below a configured or preconfigured threshold,
a reading of data from the at least one group of tags which has priority below a configured or preconfigured threshold,
checking battery levels of battery-operated radio tags,
filtering data retrieved from the radio tags based on a predefined criterion, e.g., data older than a timestamp can be discarded,
sending configuration updates to one or more radio tags, e.g., changing group memberships of radio tags,
a detection for the presence of radio tags.

In accordance with embodiments, the certain signaling from the RAN entity is responsive to the RAN entity determining one of more of the following:
the certain status of the reader device,
the certain status of the wireless communication system,
the certain communication with the at least one radio tag,
the certain radio tag operation to be performed by the reader device,
In accordance with embodiments, responsive to one or more leave conditions, the reader device is to leave the radio tag mode.

In accordance with embodiments, when leaving the radio tag mode, the reader device is to transition into a connected state in which a transfer of data collected by the reader device from the reader device to the RAN entity is possible.

In accordance with embodiments, when leaving the radio tag mode, the reader device is to transition into an inactive state, in which the reader device is capable to transmit and/or receive certain control and/or data signaling from the RAN, e.g., one or more of the following:
a synchronization signal,
a paging signal,
a control signal,
a data signal.

In accordance with embodiments, the one or more leave conditions comprise one or more of the following:
a data volume received from the at least one radio tag and buffered by the reader device reaches a configured or preconfigured threshold,
a configured or preconfigured time has elapsed,
   since the reader device started operating in the radio tag mode, or
   a general timer, e.g., every 12 hours, or every 24 hours, or once a week etc.,
one or more configured or pre-configured events, e.g., an emergency alert, which may include scenarios such as environmental warnings, system failures or security alerts, intrusion detection, production start, inventory alerts, reception of high priority data from the at least one radio tag,
an improvement of a status of the wireless communication system, e.g., a signal quality on a channel between the reader device and the RAN entity exceeding a configured or preconfigured threshold, e.g., one or more of a Radio Signal Strength Indicator, RSSI, a Signal to Noise Ratio, SNR, a Signal to Interference plus Noise Ratio, SINR, or a Reference Signal Received Power, RSRP, exceeding a certain level,
a switch of the RAN entity, e.g., when the reader device moves from a cell served by the RAN entity to another cell served by another RAN entity,
an indication from the RAN entity causing the reader device to transition into a connected state in which a data transfer between the reader device and the RAN entity is possible.
a detection of mobility, e.g. changing from a static to a mobility state or exceeding a certain speed,
a low battery level, e.g., a transmission of collected data during the radio tag mode once the battery level falls below a configured or preconfigured threshold,
leaving a certain area and/or geo-location, e.g., moving further than a certain distance, e.g., moving 10 meters,
entering a certain area and/or geo-location, e.g., moving into the coverage of a base station or a beam of a base station, e.g., a beam having a certain beam ID.

In accordance with embodiments, when operating in accordance with the radio tag mode, the reader device is to perform one or more of the following operations:
receiving and/or reading of data from the at least one radio tag,
buffering the data received form one or more radio tags, e.g., until the data transfer between the reader device and the RAN entity is possible,
a transmission or writing of data to the at least one radio tag, e.g., updating the group membership of one or more radio tags, changing parameters such as reporting intervals, modifying security settings,
performing one or more commands for one or some or all of the plurality of radio tags, e.g., configuring alerts on when and how the radio tag can trigger alerts or generate data, activating or deactivating functionalities such as enabling a specific feature,
aligning internal clocks of the radio tags with a reference time to minimize clock drift due to different clock capabilities,
detecting the presence of radio tags,
disabling or deactivation of radio tags, e.g., sending radio tags into a DRX or eDRX or a deep sleep mode, e.g., where radio tags can only be enabled or activated by a certain signal, e.g., a carrier wave signal, CW,
reading and writing of radio tags locally.

In accordance with embodiments, the reading of data comprises a periodic or aperiodic collection of data from the at least one radio tag.

In accordance with embodiments, the reader device performs one or more of the following operations:
a local buffering of the collected data,
an aggregation of the collected data,
a compression of the collected data,
a calculation of the collected data, e.g., calculating a minimum, a maximum, a sum, a difference, a multiplication, a division, a transformation, or any combination thereof.

In accordance with embodiments, the reader device is to communicate with
a core network of the wireless communication system using a first communication protocol or a core interface, and
the radio tag using a second communication protocol or an A-IoT radio interface.

In accordance with embodiments,
the wireless communication system comprises one of the following: a 3GPP network or a WiFi network or an Radio-frequency identification, RFID, network,
the first communication protocol is one of the following:
   a 3GPP communication protocol, e.g., A-IoT or NB-IoT or eMTC or LTE-M, or
   a non-3GPP radio, e.g., WiFi communication protocol or an RFID communication protocol or a lower power wide area protocol, LPWA, e.g., Mioty®, or a satellite radio protocol, e.g., Iridium®, and
the second communication protocol is the same as or different from the first communication protocol.

In accordance with embodiments, the radio tag comprises one the following:
an IoT Internet-of-Things, IoT, device,
an NB-IoT or eMTC device,
a low power wide area device, LPWA,
an Ambient IoT device,
a sensor device,
an actuator device,
a passive device,
a device without active transmitter, using backscatter communication, e.g. of a carrier wave, CW, signal,
an Radio-frequency identification, RFID, device, like an RFID tag.

In accordance with embodiments, the reader device comprises one the following:
a mobile terminal of a wireless communication network, e.g., a user equipment, UE, of a 3GPP network or of a WiFi network, e.g., a wireless station, STA, of a WiFi network or a WiFi access point, AP,
an Radio-frequency identification, RFID, device, like an RFID reader.

The present invention provides a radio tag for communicating with a reader device of any of the embodiments of the present invention.

In accordance with embodiments,
the radio tag comprises an A-IoT device which communicates with the A-IoT reader using an A-IoT radio interface, the A-IoT radio interface supporting one or more A-IoT procedures, the A-IoT procedure comprising an A-IoT paging, an A-IoT access procedure and a D2R data transmission performed during the A-IoT procedure, and
the D2R transmission by the radio tag comprises a D2R upper layer data transfer message for a segment of the data transmission which includes:
   a SDU length field,
   a data SDU field which is set to include the segment, and
   a more data indication field, wherein the more data indication field is set to 0, if the segment is the last segment of an original upper layer data SDU, and wherein the more data indication field is set to 1, if the segment is not the last segment of the original upper layer data SDU.

In accordance with embodiments, the radio tag is to transmit a data transmission to the reader device such that an initial part of the data transmission is transmitted during a first time period, and a further part of the data transmission is transmitted during a second time period, the second time period following the first time period with an offset, which may be zero.

In accordance with embodiments, the radio tag is to
omit an end of transmission signaling in the initial part of the data transmission, like an end-bit, or
include a signaling in the initial part of the data transmission indicating one or more of the following:
   a presence of one or more additional parts of the data transmission,
   a further part of the data transmission,
   a last part of the data transmission,
   a number of further parts of the data transmission,
   an availability of other data transmissions,
   a size of the data transmission,
   a remaining size of the data transmission,
   a number of other data transmissions,
   one or more further control data transmissions, e.g., a CRC checksum, device or group IDs, power state.

In accordance with embodiments the radio tag comprises:
a backscatter transmitter for transmitting a signal using a backscattered signal,
wherein the radio device is to receive an incident signal from the radio transmitter apparatus and transmit the signal using the backscattered signal responsive to the incident signal.

In accordance with embodiments, the radio device comprises one the following:
an IoT Internet-of-Things, IoT, device,
an NB-IoT or eMTC device,
a low power wide area device, LPWA,
an Ambient IoT device,
a sensor device,
an actuator device,
an Radio-frequency identification, RFID, device, like an RFID tag.

The present invention provides a wireless communication network, comprising:
one or more reader devices of any one of the embodiments of the present invention, and/or
one or more radio tags of any one of the embodiments of the present invention.

The present invention provides a method for operating a reader device for communicating with at least one radio tag of a plurality of radio tags, wherein the reader device is connectable to or is deployed within a radio access network, RAN, entity of a wireless communication system and to one or more or all of the plurality of radio tags, the method comprising:
responsive to one or more conditions, operating the reader device in accordance with a radio tag mode, e.g. an A-IoT mode, in which a data transfer between the radio device and the at least one radio tag is enabled.

The present invention provides a computer program product comprising instructions which, when the program is executed by a computer, causes the computer to carry out one or more methods in accordance with the present invention.

### BRIEF DESCRIPTION OF THE DRAWINGS

Embodiments of the present invention will be detailed subsequently referring to the appended drawings, in which:

FIG. 1 illustrates the radio resource control, RRC, states in accordance with the 3GPP standard,

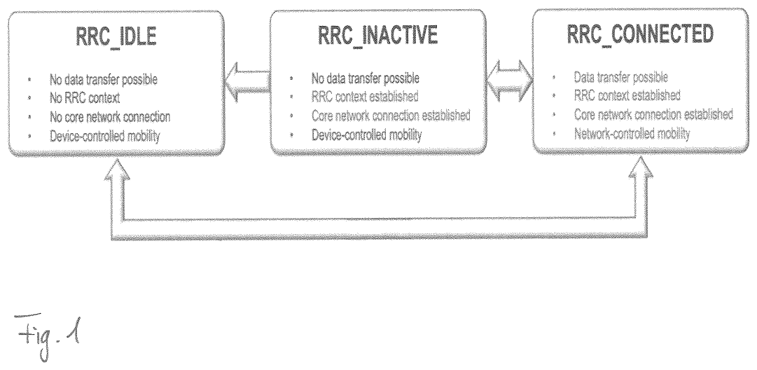

FIG. 2 illustrates a topology for a communication between a radio tag, like an Ambient IoT device, and a wireless communication system or network operating in accordance with the 3GPP standard,

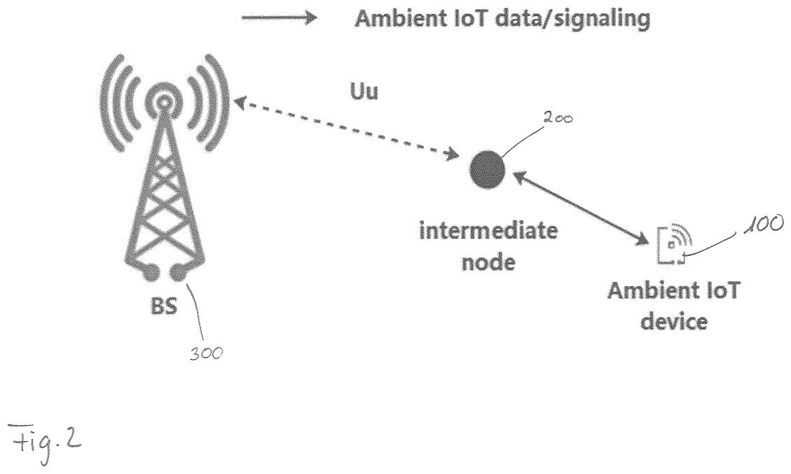

FIG. 3 illustrates a schematic representation of a wireless communication system for implementing a radio tag and an intermediate node or reader device in accordance with embodiments of the present invention,

FIG. 4 illustrates a reader device in accordance with embodiments of the present invention,

FIG. 5 illustrates an out-of-coverage scenario causing a reader device to enter into a radio tag mode in accordance with embodiments of the present invention,

FIG. 6 illustrates a handling packet segmentation in accordance with embodiments of the present invention,

FIG. 7(A) and FIG. 7(B) are schematic representations of an example of a terrestrial wireless communication network in which embodiments of the present invention may be implemented, and

FIG. 8 illustrates an example of a computer system on which units or modules as well as the steps of the methods described in accordance with the inventive approach may execute.

### DETAILED DESCRIPTION OF THE INVENTION

In the following description of embodiments of the present invention, in the accompanying drawings the same or similar elements have assigned the same reference signs.

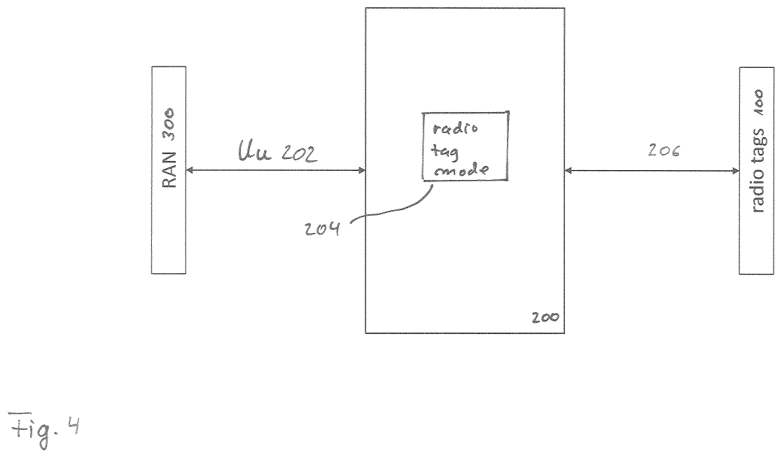

FIG. 4 illustrates a reader device 200 in accordance with embodiments of the present invention. The reader device, like a UE or a WiFi device operates, when certain one or more conditions apply, e.g., being in inactive or idle state, in a mode in which a data transfer with one or more radio tags 100, like an ambient IoT device or RFID device, is possible or enabled. Stated differently, the reader device 200 is for communicating with at least one radio tag 100 of a plurality of radio tags. The reader device is connectable to a radio access network, RAN, entity 300 of a wireless communication system, e.g., using a Uu link 202, and to one or more or all of the plurality of radio tags 100. Responsive to one or more conditions, the reader device 200 operates in accordance with a radio tag mode 204, e.g. an A-IoT mode, in which a data transfer 206 between the reader device 2000 and the at least one radio tag 100 is enabled. In accordance with embodiments, when being in the radio tag mode 204 no data transfer is enabled with the RAN entity 300 over the Uu link 202, e.g., in case the reader device is in an RRC_IDLE state, in an RRC_INACTIVE state or in an out-of-coverage state. In accordance with embodiments, the reader device 200 may be a network entity of a 3GPP wireless communication network, for example a user equipment, UE. In accordance with other embodiments, the radio device may be a WiFi device of a WiFi network. In accordance with yet other embodiments, the radio device 200 may be an RFID-reader having an interface to the wireless communication network.

In accordance with embodiments, the radio tag 100 may be an ultra-low complexity IoT device having an ultra-low power consumption in accordance with the 3GPP standards. In accordance with other embodiments, the radio tag 100 may be a device operating in accordance with the WiFi standard. In accordance with yet other embodiments, the radio tag 100 may be an RFID device, like an RFID tag.

In accordance with embodiments, the radio tag 100 is a wireless device capable to transmit and/or receive radio frequency signals to/from one or more reader devices 200.

In accordance with embodiments, the radio device 100 includes a backscatter transmitter for transmitting a signal using a backscattered signal.

Thus, embodiments of the present invention address the issues and problems encountered in conventional technology approaches by operating the intermediate node 200 in a specific or dedicated mode, also referred to as a radio tag mode or an Ambient IoT mode. The radio tag mode is referred to herein also as an A-IoT mode or as an A-IoT-standby, A-IoT STBY, state. In accordance with embodiments, the intermediate node may be a UE, an IAB node, a relay or a repeater capable of managing communications with the radio tag 100. During the radio tag mode, for example when being in the A-IoT STBY state, the intermediate node 200 may perform a periodic data collection and a local buffering of the collected data while remaining in a non-connected state with regard to the RAN entity, for example, while remaining in an RRC_INACTIVE state or in an RRC_IDLE STATE. This avoids the high energy costs associated with maintaining a continuous connected state, like a continuous RRC_CONNECTED state with the RAN entity. For example, when considering a scenario of a smart warehouse, the intermediate node 200 may gather data from radio tags monitoring environmental metrics, like a temperature and a humidity. By leveraging the non-connected states, the intermediate node 200 may remain in a low-power state or in an energy saving state while collecting the data and storing the collected data locally, i.e. on the intermediate node 200. For example, once a sufficient amount of data is buffered, the intermediate node 200 may briefly transition to the connected state for sending all data which has been collected and buffered during the radio tag mode at once.

As mentioned above, the intermediate node or reader device 200 may enter into the radio tag mode responsive to one or more conditions. In accordance with embodiments, these one or more conditions may include one or more of the following:
a certain status of the reader device,
a certain status of the wireless communication system,
a certain communication with the at least one radio tag,
a certain status of the at least one or more radio tags, e.g., a radio tag being in an active state,
a certain radio tag operation to be performed by the reader device,
a certain signaling from the RAN entity causing the reader device to operate according to the radio tag mode.

In accordance with embodiments, the status of the reader device 200 may be an operating status of the reader device or a connection status of the reader device 200 with the RAN entity 300, or a geo-location of the reader device.

When considering the geo-location of the reader device 200, the reader device or intermediate node 200 may enter into the radio tag node when the reader device 200 is within a configured or preconfigured communication range with respect to one or more radio tags 100 or in case the reader device 200 is within a configured or preconfigured distance from one or more radio tags. Stated differently, as long as there are no radio tags to query by the reader device 200, the reader device may maintain in a non-connected state with regard to the wireless communication network and only once one or more radio tags are detected to be within the minimum communication range or within a predefined distance, for example due to the reader device 200 and/or the radio tags 100 moving around, the reader device 200 activates the radio tag mode for querying the at least one radio tag which is within its communication range or within its communication distance. In accordance with embodiments, before entering into the radio tag mode, the reader device 200 may be in a low power reader state in which the reader monitors its radio environment for radio tags coming into its communication range, for example, by periodically checking for radio tags and entering into the active reader state, i.e., into the radio tag mode once one or more tags are detected within the communication range of the reader device 200. In accordance with embodiments, the radio text status may only be triggered in case the reader device 200 is within the range of at least one radio tag, or is within the range of n radio tags with n>1, or is within the range of a group of radio tags which may be identified by a respective group identifier, or is within a range of a certain type of radio tags. Here, a radio tag may be associated with a certain type, e.g., grouped by a similarity or belonging to the same product. E.g., parts of an object may be of the same type, e.g., car parts belonging to the same car, or parts of the same type, e.g., a steering wheel, belonging to different objects, e.g., the same car part belonging to a set of cars. Another example is an external condition, e.g., radio tags experiencing a similar environmental value, e.g., temperature or acceleration, may belong to the same type, e.g., all radio tags which experienced a fast acceleration would trigger a reader device, while others which have not experienced such an external event, may not trigger a reader device. This could be used in logistics for asset tracking to find out about the health status of an object, e.g., an object has tipped over or fallen from a certain height or experienced a high temperature or absorbed a shock.

In accordance with embodiments, the operating status of the reader device 200, dependent on which the reader device enters or activates the radio tag mode, may comprise the energy level at the reader device. For example, the reader device may operate in the radio tag mode if the battery level or an amount of energy harvested over a certain period drops below a configured or preconfigured threshold.

In accordance with other embodiments, the operating status of the reader device may be an available memory storage level. For example, the reader device may operate in the radio tag mode if the available memory storage is above a configured or preconfigured threshold, i.e., the reader device is actually in a condition which allows collecting and buffering data from the one or more radio tags. In case buffering further data may no longer be possible at the reader device, the reader device 200 may leave the radio tag mode and enter into a connected node for forwarding the buffer data to the RAN entity.

In accordance with yet other embodiments, the operating status of the reader device may be indicated by an external signal, like a presence detection, a movement of the reader device or the detection of a 3GPP or a non-3GPP wireless signal. In one embodiment, a reader device may detect a signal transmitted from another 3GPP device, e.g., a UE or a gNB, or a particular UE, e.g., a NB-IoT UE, which may indicate the operating status of the reader device. In a further embodiment, this may also be provided by a non-3GPP device, e.g., a WiFi AP or a LWPA system, e.g., a SigFox or LoRa or mioty device.

There are several types of sensors that are commonly used for presence detection in various applications, including IoT devices, security systems, smart homes, and industrial automation. Some examples of sensors that can be used for presence detection are passive infrared (PIR) motion sensors, ultrasonic Sensors, capacitive proximity sensors, laser distance sensors, microwave radar sensors, or image sensors. These sensors can also be used to detect movements, e.g., movement of the reader device. Other examples of sensors which can be used to detect movement are accelerometers or gyroscopes.

In a further embodiment the reader device is only activated when the presence detection indicates the presence or movement of one or more objects or tags.

In accordance with yet further embodiments, the operating status of the reader device may also include environmental parameters impacting an operation of the reader device, like a temperature, a humidity, an air quality and the like in the environment in which the reader device is located. For example, in case one of the parameters, like the temperature, exceeds a certain threshold, the processing efficiency may drop at the reader device causing the reader device, for conserving energy, to change into the radio tag mode which requires less processing power than maintaining the connected state with the RAN entity.

In accordance with other embodiments, the status of the reader device may include a mobility characteristic. For example, when the reader device is moving, it may release the assigned resources when detecting the mobility or when moving further than a certain distance from its original position. On the other hand, when the reader device is static it may continue using the assigned resources for a pre-configured amount of time before releasing the resources.

In accordance with embodiments, the connection status of the reader device which decides on whether entering the radio tag mode may be a non-connected state in which no transfer of data gathered from the radio tag from the reader device 200 to the RAN entity 300 is possible. This non-connected state may include an idle state in which no data transfer at all is possible between the reader device and the RAN entity, or it may be an inactive state in which only certain messages, like control messages, may be exchanged between the reader device and the RAN entity. In case the reader device enters the non-connected state, it may enter the radio tag mode. In accordance with embodiments, the just-mentioned certain messages that may be transmitted during an inactive state include one or more of the following:
a wake-up signal, WUS,
a synchronization signal, e.g., PSS and/or SSS,
a broadcast message,
a control message, e.g., PHY and/or MAC-CE and or RRC,
a start indicator.

In accordance with other embodiments, the connection status may indicate that the wireless communication network or the RAN thereof does not support operating the reader device in the radio tag mode so that, in such a situation, when the connection with the RAN does not support the radio tag mode, the reader device refrains from entering the radio tag mode independent of any further condition.

In accordance with other embodiments, a device-to-device state may decide on whether or not the radio tag mode is entered by the reader device. For example, when the reader device enters the device-to-device state, for example, when communicating with other user devices or reader devices using the PC 5 interface without any connectivity to the network via the Uu link, the reader device may enter the radio tag mode. For example, when implementing the reader devices as UEs of the wireless communication network operating in mode 2 in accordance with NR, a reader device operating in mode 2 may initiate or enter into the radio tag mode.

In accordance with yet further embodiments, the reader device may enter into the radio tag mode responsive to being in an out-of-coverage state, i.e., in a state in which there is no connection to the RAN entity and/or in case the RAN entity does not support the reader device with regard to the resource allocation.

In accordance with embodiments, the reader device may be in the out-of-coverage state responsive to a radio link failure, RLF, a handover, HO, or conditional handover, CHO, failure, a hard handover, for example in case a serving cell connection is released before the candidate cell connection is engaged, also referred to as break-before-make, BBM. Further, when detecting a ping pong effect, the reader device may determine an out-of-coverage state resulting in entering the radio tag mode. For example, when a given number of transmissions between respective connectivity states, i.e., respective transmissions between a state in which the reader device is attached and not attached to the RAN entity, are encountered, exceeds a configured or preconfigured threshold within a time interval, the reader device judges a non-reliable connection over the Uu link and enters the radio tag mode. Another situation in which an out-of-coverage state is determined by the reader device is when the base station or RAN entity does not support the recess allocation, i.e., responsive to not receiving any resource allocation configuration or assistance from the RAN entity, the reader device enters into the radio tag mode.

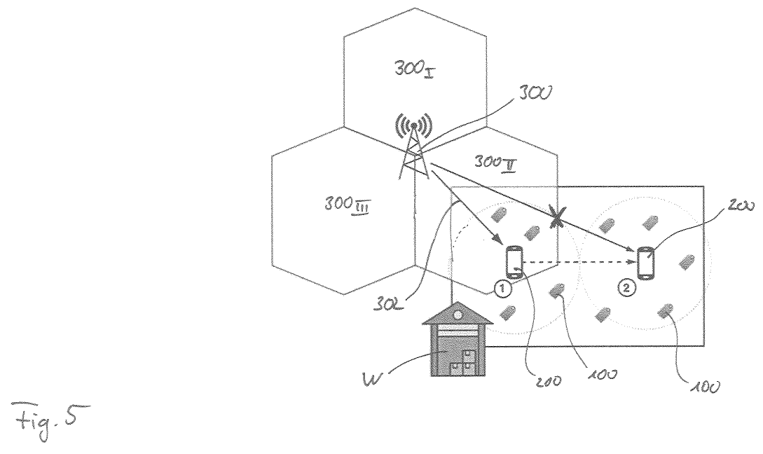

FIG. 5 illustrates an embodiment of an out-of-coverage scenario causing a reader device 200 to enter into the radio tag mode. FIG. 5 illustrates a base station 300 as an example of a RAN entity having in coverage area 300_{I} to 300_{III}. At a time □, the reader device 200 is within the area 302_{II} of the coverage of the base station 300 and is in a connected state via the Uu link 302. FIG. 5 illustrates a number of radio tags 100 which may be radio tags attached to devices or goods within a factory or a warehouse W. Within the warehouse W or factory, the reader device 200 may move, as is indicated by the dotted arrow in FIG. 5, so that the reader device at a time □ is located outside the coverage of the base station 300 so that the Uu link is not interrupted as is indicated in FIG. 5 by the χ. Thus, due to the mobility nature, the intermediate mode 200, in accordance with embodiments, it may happen that it moves out of the coverage area 300_{I} to 300_{III} of the RAN entity 300. As illustrated in FIG. 5, a UE 200 may act as the intermediate node for the A-IoT devices 100 inside the warehouse W. As the UE 200 travels through areas with poor or no network coverage, the UE 200 may lose its direct connection with the base station 300, at time □ indicated in FIG. 5. In such cases, if the UE 200 were restricted to only RRC_CONNECTED mode for the data collection, it would be unable to gather any data from any of the A-IoT devices 100 until regaining coverage. Embodiments of the present invention described herein cover such a situation by providing the radio tag mode. For example, the UE 200 may be configured with a A-IoT-STBY configuration so that it can activate the radio tag mode functionality once losing connection to the base station 300. Thereby, the UE 200 is enabled to operate in the non-connected mode which, in turn, enables the data collection from A-IoT devices 100 within the communication range of the UE 200 at the time □. Once the UE 200 moved further and re-established the connection 302 to the base station 300, the data from the radio rags 100, which may been collected and buffered by the intermediate node or UE 200, may be sent to the base station 300.

In accordance with embodiments, the intermediate node or UE 200 may be configured or preconfigured to enter into the radio tag mode after moving out of the coverage area 300_{I} to 300_{III} of the base station 300 serving the UE 200. In accordance with embodiments, as mentioned above, moving out of the coverage area of the base station 300 may be due to a radio link failure, a handover failure, or a ping pong effect detection. In such situations, as mentioned above, the intermediate node or UE 200 activates the radio tag mode so as to be in a position to still gather data from radio tags within the communication range around the UE 200.

In accordance with embodiments, responsive to moving out of the coverage area of the base station, the intermediate node or UE 200 may be configured or preconfigured to retain resources allocated for the radio tag communication. In accordance with other embodiments, the UE 200 may use a dedicated set of resources or a dedicated resource pool which is configured to be active in case of a loss of connectivity for the communication with the radio tags. For example, a UE may use a resource pool of dedicated resources responsive to detecting a radio link failure. In accordance with embodiments, the allocated resources for the radio tag communications may be retained for a certain period. The intermediate node 200 may be configured or preconfigured with a timer, an offset, a threshold or an event indicating a validity of the allocated resources. For instance, upon determining a movement out of the coverage area, the intermediate node 200 may set a timer to a configured or preconfigured value, like 30 minutes, during which the resources are considered valid. Following the lapse of the timer, the resources are no longer considered valid and the reader device 200 stops communicating with the radio tags. In accordance with yet further embodiments, the timer may also be used to determine a period during which the reader device is allowed to operate in the radio tag mode, either using the allocated resources or the configured or preconfigured dedicated resources. For example, the UE 200 may be configured to operate for the duration of the timer in the radio tag mode and, once the timer lapsed, the UE is to leave the radio tag mode and stop collecting data from the radio tags. In a further example, the UE actively monitors specific operational conditions, such as channel quality degradation or repeated access attempt failures, and responsive to an event, e.g., signal strength lower than a threshold, is to determine the validity of the resources.

In accordance with further embodiments, the validity of the collected and buffered data, while being in the out-of-coverage state, may be determined using a timer. The intermediate node or UE 200 may be configured or preconfigured with a timer, an offset or a threshold for determining the validity of the data collected during the out-of-coverage scenario. For instance, the intermediate node 200 may set a timer to a configured or preconfigured value, like 30 minutes, which may indicate that after the expiration of the timer, the data stored in the buffer is no longer of value and, therefore, has to be discarded. For example, this may be used when a scenario occurs in which certain tags need to be queried periodically and the data needs to be provided with the same periodicity to the base station. In case the out-of-coverage state extends too long, the buffered data may not be accepted by the base station any more as valid data and, therefore, can be discarded. This may be the case if the data to be provided by the radio tag is sensor related data which is only valid for a certain time period. Another example where this may be useful is if radio tags are integrated into a more complex object. In this example, once the complex object is assembled, it may not be of interest by the network and/or the reader device to receive certain data from all individual radio tags.

In accordance with further embodiments, responsive to the lapse of the configured or preconfigured timer, the reader device 200 may continue the communication with one or more of the radio tags, i.e., the reader device stays in the radio tag mode after a lapse of the timer and uses the allocated or preconfigured resources for the communication. In accordance with other embodiments, once the timer has lapsed, the reader device 200 may start or activate a communication with the radio network so as to regain the connection to the network, for example, via the Uu link or via a direct communication interface, like the PC5 interface, with the RAN node 300. In accordance with yet other embodiments, responsive to the timer lapsing, the UE may change its state to a discontinuous reception mode, DRX or eDRX. In accordance with other embodiments, the reader device, responsive to the timer having lapsed, may start a cell search or may perform a random access, PRACH, to the base station.

The pre-configured set of resources may be used to start or continue a communication with the radio tags, for example, the set of resources may be from an exceptional pool of resources. The exceptional pool of resources may be used during a handover or a RLF to continue the radio tag communication until the new resources are assigned by the network by the new base station in case of a handover or by the base station to which connection was regained following the RLF. For instance, in the case where the UE can operate as intermediate node across multiple-cells, the validity of the resource pool can be set to cells with the same operational parameters such as carrier frequency.

In accordance with yet other embodiments, the intermediate node 200 may be configured or preconfigured to adjust a resource retention based on its mobility. For example, if the intermediate mode leaves a given area, like a paging or tracking area, the resources may be released promptly, and the reader device leaves the radio tag mode.

In accordance with yet other embodiments, when being in an out-of-coverage state, for obtaining valid resources for a communication with the radio tags in the radio tag mode, the UE 200 may receive a set of preferred and/or non-preferred resources from another device, for example via a direct interface using, for example, inter-UE coordination information, IUC, messages. The other device may be a UE, another reader device, an IoT device, a base station, like a gNB, a non-terrestrial network, NTN, or drone, or a radio tag.

In accordance with other embodiments of the present invention, the radio tag mode may also be dependent on a certain status of the wireless communication system. In accordance with embodiments, in case a signal quality on a channel between the reader device and the RAN entity drops below a configured or preconfigured threshold, which will be indicative of a starting loss of connection, the reader device may enter into the radio tag mode for ensuring a continuous communication with the radio tags. For example, this may be decided in case one or more of a radio signal strength indicator, RSSI, a signal-to-noise ratio, SNR, a signal-to-interference-plus-noise ratio, SINR, or a reference signal receive power, RSRP, fall below a certain level. In such situations the reader device, by means of entering the radio tag mode, is capable to buffer data from the radio tags until the network conditions improve so as to allow for a reliable and successful transmission of the collected data from the RFID tags to the base station.

In accordance with other embodiments, the radio tag mode may be used during a specific time. For example, during times when a load in the wireless communication system is above a configured or a preconfigured threshold, like peak hours, the reader device may operate in the radio tag mode for collecting and buffering data from the radio tags but refraining from a transmission to the base station, thereby avoiding congestions and collisions on the Uu link. On the other hand, during a quiet period, for example, in case there is data traffic below a certain threshold in the network, the reader device may also operate in the radio tag mode. For instance, this may be the case when the network performs network energy saving, NES, for example during nighttime, and in such a situation, only a reduced number of base stations may be active or activated. The base station serving the reader device may not be activated or may even be powered down so that in such a scenario, the reader device collects and buffers data from the radio tag so as to forward the data to the RAN once the NES is deactivated, i.e., once the base station serving the reader device is activated again.

In accordance with further embodiments, the status of the wireless communication system may also refer to a specific location or geographical area in which the reader device is located. For instance, the reader device may be located in a restricted area or there may be a geographic boundary that limits the communication capabilities, like the minimum required communication range. In case the RAN topology is changing or in case the reader device is moving, the geographical location of the reader device is changing and so is the radio channel and/or the pass loss between the reader device and the RAN entity. The path loss between the reader device and the RAN entity may be too large so that the power amplification of the radio signals in the uplink from the reader device to the network becomes too large and drain the battery power of the reader device. In such a scenario, the reader device switches into the radio tag mode in which it communicates only with the radio tags but not with the RAN entity. The power restrictions limit the communication efforts between the reader device and the RAN entity and are only enabled in case the reader device is within a better reach of the RAN entity and/or in case the reader device has collected a certain amount of data from the radio tags that needs to be transmitted.

In accordance with yet other embodiments, the status of the communication network may be determined in a specific scenario characteristic, for example dependent on whether the reader device is located indoor, outdoor, in an urban microcell, UMI, in an urban macrocell, UMA. Thus, dependent on the specific deployment scenario mentioned above, the reader device may decide on using or not using the radio tag mode. For instance, the radio tag mode may be active for indoor scenarios in which the radio coverage to the RAN entity is poor, but may be deactivated by outdoor scenarios where a good connectivity to the RAN entity is given.

In accordance with embodiments, the reader device may enter into the radio tag mode responsive to a certain communication with the at least one radio tag. This communication may be a back scattering from the radio tag indicating a status from the radio tag, like a scheduling request. In another embodiment, the communication may include a status indication from the radio tag indicating a certain status of the radio tag, such as a specific sensor value or a power state, so that, for example, when being in a non-connected mode, responsive to a certain sensor value or power state, for example a value exceeding a threshold, the reader device may start collecting data from the respective radio tag. In accordance with yet other embodiments, the communication from the radio tag may be a feedback indication from the radio tag, like an ARQ or an HARQ feedback or a scheduling request or an initial access request.

In accordance with further embodiments, the reader device also handles a packet segmentation, i.e., receives only a first part of a data transmission from a radio tag during a first transmission instance wherein the first transmission indicates that a second part of the data transmission follows in a later transmission instance. The first transmission may be with the reader device being in the connected state in which a transfer of the data gathered by the reader device to the RAN entity is possible, while the further part of the data transmission is performed when the reader device is in the radio tag mode.

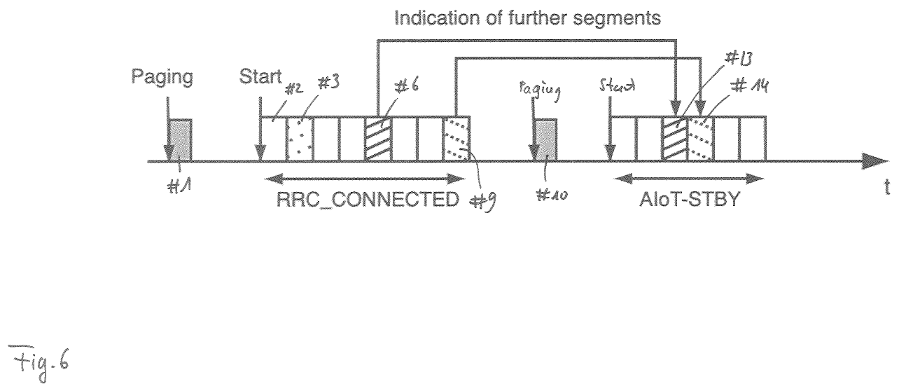

FIG. 6 illustrates an embodiment of the present invention handling packet segmentation. Dependent on the transport block size, TBS, determined by the physical layer, PHY layer, an amount of data to be transmitted by the radio tag may not fit into a single transport block that is, for example, transmitted while the reader device is in a connected state. In such a scenario, the radio tag may create multiple segments to transmit the amount of data. In accordance with embodiments of the present invention, the initial part of the data transmission may be performed while the reader device is in a connected state, while the segments, i.e., the one or more further parts of the data transmission, may be collected when the reader device or intermediate node is in the radio tag mode. In other words, in accordance with embodiments, the respective segments of a data transmission may be collected during different states of the intermediate node. FIG. 6 illustrates an embodiment in which a transmission is segmented into two segments. A paging signal is received in time slot #1. The radio tag may receive the paging signal, like an inventory round signal, from the reader device 200 and responsive to the receipt of the paging signal in time slot #1, the radio tag may communicate with the reader device, which is in the RRC_CONNECTED state, during time slots #2 to #9. During these time slots the radio tag 100 and the reader device 200 communicate with each other. For example, in time slot #3 the radio tag 100 transmits a first segment of data. Further segments of the data are transmitted in time slots #13 and #14. For the transmission of the data from the radio tag to the reader device in these time slots, the reader device issues the paging signal which is received in time slot #10 with the reader device being in the radio tag mode in which the additional segments of the radio transmission are collected by the reader device from the radio tag. In accordance with embodiments, the additional segments may be indicated during the initial transmission period, for example by transmitting a corresponding indication in time slots #6 and #9.

In accordance with embodiments, the intermediate node 200 may be configured or preconfigured to receive a predetermined number of packets or segments from each radio tag while in the RRC_CONNECTED state. For instance, the intermediate node 200 may be set to receive up to two segments per device in the RRC_CONNECTED state before deferring any further transmissions from the radio tags to the radio tag mode.

In accordance with other embodiments, the intermediate node may receive an initial or first segment during its RRC_CONNECTED state, which includes an explicit or implicit indication that additional segments of the transmission remain. The subsequent segments may be received while the intermediate node is the radio tag mode. An implicit indication may be the absence of an end-bit in the initial transmission signaling to the intermediate node that additional segments are pending.

In accordance with yet other embodiments, the intermediate node may be configured or preconfigured to schedule radio tags, like A-IoT devices, having multiple segments onto a reserved set of resources while being in the radio tag mode. For instance, instead of performing a contention-based random access, CBRA, attempt, radio tags that retransmit data in multiple segments may be scheduled with configured resources using a contention-free random access, CFRA.

In accordance with embodiments, the transmission from the radio tag to the reader device may explicitly or implicitly indicate one or more of the following:
a further part of the data transmission,
a first part of the data transmission,
a last part of the data transmission,
a number of further parts of the data transmission,
an availability of other data transmissions,
a size of the data transmission,
a remaining size of the data transmission,
a number of other data transmissions,
one or more further control data transmissions, e.g., a CRC checksum, device or group IDs, power state.

In accordance with embodiments, the presence of additional segments may be explicitly signaled by using an indication of the further segments in a way as illustrated in FIG. 6.

In accordance with further embodiments, the reader device 200 may decide on entering the radio tag mode dependent on a certain radio tag operation to be performed by the reader device.

In accordance with embodiments, when determining one or more non-time critical operations, for example a routine inventory scan through a plurality of radio tags, it may be performed with the reader device being in the radio tag mode. For example, in a factory setting, the base station or gNB 300 may configure the intermediate UE 200 to perform non-critical operation in the radio tag mode.

In accordance with other embodiments, the reader device may enter into the radio tag mode for performing one or more commands for one or some or all of the plurality of radio tags following a reading of data from the radio tags in a connected state in which the transfer of the data from the radio tags to the RAN entity via the reader device is possible. Stated differently, a first operation may be performed by the reader device while in the RRC_CONNECTED state, whereas a subsequent operation may be carried out by operating in the radio tag mode. For example, the intermediate node may perform an initial inventory operation while being in the RRC_CONNECTED state, and then switch to the radio tag mode to perform a transmission of further commands, such as a write or read command for a subset of the radio tags. In accordance with embodiments, the one or more commands issued by the reader device to the radio tag during the radio tag mode may include commands for checking a battery level of battery operated radio tags or the sending of configuration updates to the radio tags, for example when changing a group membership of one or more radio tags.

In accordance with yet other embodiments, the reader device may query a radio tag which has a low priority when being in the radio tag mode. For instance, the radio tag mode may be configured or preconfigured to target a specific radio tag or a specific group of radio tags. High priority tags or groups of radio tags may be inventoried during the RRC_CONNECTED state so as to ensure that the collected data is directly transmitted from the reader device to the RAN entity, while less relevant radio tags or groups may be inventoried during the radio tag mode. Such less relevant radio tags may provide data that may be buffered for a certain time before it is forwarded from the reader device to the RAN entity. An example for this are sensors carrying sensor data of a critical infrastructure, e.g., fire sensors or intrusion detection sensors, where the forwarding of this data with low delay and high reliability is of high priority, whereas the sensor data of a normal temperature sensor which stays within a certain min/max threshold is not of highest importance. For this, the data can be stored and forwarded at a later stage.

In accordance with further embodiments, the reader device may also be operated in the radio tag mode when filtering data received from the radio tags based on a certain criterion, for example for data being older than a certain time stamp and, therefore, being data to be discarded, or for performing a detection of the presence of any radio tags within the communication range of the reader device.

In the embodiments described so far, the radio tag mode has been entered by the reader device responsive to certain conditions detected or determined by the reader device. However, in accordance with further embodiments, the reader device may enter into the radio tag mode also responsive to a signaling from the RAN entity. For example, the RAN entity may determine the above described certain status of the reader device or the certain status of the wireless communication system or the certain communication with the at least one radio tag or the certain radio tag operation to be performed by the reader device, and, responsive to the detection, may signal the reader device 200 to enter into the radio tag mode. Thus, in accordance with such embodiments, the intermediate node may be configured or preconfigured to enter the radio tag mode through a direct indication, for example through an RRC message, an MACCE or a SIB, that is received from the base station 300.

In accordance with yet further embodiments of the present invention, one or more conditions may be configured for allowing the intermediate node or reader device 200 to leave the radio tag mode and transition, in accordance with further embodiments, into the connected state again. In accordance with other embodiments, the intermediate node or reader device 200 may transition, responsive to one or more leave conditions, from the radio tag mode into an inactive state in which the reader device may transmit and/or receive certain control and/or data signaling from the RAN, for example a synchronization signal, a paging signal, a control signal or a data signal. Although user data cannot be transmitted for UEs in inactive state, there may be certain configurations, where a small amount of data, e.g., radio tag related data, could be transmitted from the intermediate node or reader device to the network, or to one or more radio tags. One example for this could be the transmission of high priority sensor data to the network, e.g., sensor data of an alarm sensor, or high priority transmissions of radio tag specific control and/or data messages from the intermediate node or reader device to the radio tag.

In accordance with embodiments, the leave condition may be a data volume received from a radio tag and buffered by the reader device reaching a configured or preconfigured threshold. For example, the reader device may leave the radio tag mode in case the amount of buffered data occupies a substantial percentage of the available memory space in the reader device so that, for avoiding any loss of collected data because it cannot be buffered, the reader device enters into the connected state for transmitting the buffered data to the RAN entity 300.

In accordance with other embodiments, the reader device 200 may leave the radio tag mode once a configured or preconfigured time has elapsed, for instance once a certain time since the reader device started operating in the radio tag mode lapsed or responsive to a general timer, for example every 12 hours or every 24 hours or once a week. In accordance with yet other embodiments, the reader device may leave the radio tag mode responsive to one or more configured or preconfigured events, for example an emergency alert which may include scenarios such as environmental warnings, system failures or security alerts, intrusion detection production start inventory alerts reception of high priority data from at least one radio tag. In accordance with yet other embodiments, in a situation in which the reader device entered into the radio tag mode due to deteriorating network conditions, responsive to an improvement of the status of the wireless network the reader device may leave the radio tag mode. For example, when the signal quality on a channel between the reader device and the RAN entity exceeds a configured or preconfigured threshold, the reader device may leave the radio tag mode. For example, this may occur once one or more of a radio signal strength indicator, RSSI, a signal-to-noise ratio, SNR, a signal-to-interference-plus-noise ratio, SINR, or a reference signal receive power, RSRP, exceeds a certain level.

In accordance with further embodiments, the reader device may leave the radio tag mode when switching the RAN entities, for example during a handover process when the reader device moves from a cell served by the current RAN entity to a cell served by another RAN entity.

In accordance with yet other embodiments, the reader device may also return from the radio tag mode to another state or mode responsive to a signaling or indication of the RAN entity so as to cause a transition into a connected state in which a data transfer between the reader device and the RAN entity is possible.

In accordance with yet further embodiments, the conditions for leaving the radio tag mode may include one more of the following:
a detection of mobility, e.g. changing from a static to a mobility state or exceeding a certain speed,
a low battery level, e.g., a transmission of collected data during the radio tag mode once the battery level falls below a configured or preconfigured threshold,
leaving a certain area and/or geo-location, e.g., moving further than a certain distance, e.g., moving 10 meters,
entering a certain area and/or geo-location, e.g., moving into the coverage of a base station or a beam of a base station, e.g., a beam having a certain beam ID.

As has been described above with reference to various embodiments, during the radio tag mode, the reader device may perform one or more operations. One of the most prominent operations is the reading and/or receiving of data from the one or more radio tags.

In accordance with further embodiments, the reader device 200 may perform, when operating in accordance with the radio tag mode, one or more of the following operations:
receiving and/or reading of data from the at least one radio tag,
buffering the data received form one or more radio tags, e.g., until the data transfer between the reader device and the RAN entity is possible,
a transmission or writing of data to the at least one radio tag, e.g., updating the group membership of one or more radio tags, changing parameters such as reporting intervals, modifying security settings,
performing one or more commands for one or some or all of the plurality of radio tags, e.g., configuring alerts on when and how the radio tag can trigger alerts or generate data, activating or deactivating functionalities such as enabling a specific feature,
aligning internal clocks of the radio tags with a reference time to minimize clock drift due to different clock capabilities,
detecting the presence of radio tags,
disabling or deactivation of radio tags, e.g., sending radio tags into a DRX or eDRX or a deep sleep mode, e.g., where radio tags can only be enabled or activated by a certain signal, e.g., a carrier wave signal, CW,
reading and writing of radio tags locally, e.g., in a factory a spray-painting robot may be set to reads a color of the object the tag is attached to and paint it accordingly; a successful painting of the object may be written back to the tag, wherein the reading and/or writing operation may be performed locally without going through the network.

The reading of data may include a periodic or aperiodic collection of data from the at least one radio tag, and the reader device may perform one or more of the following operations:
a local buffering of the collected data,
an aggregation of the collected data,
a compression of the collected data,
a calculation of the collected data, e.g., calculating a minimum, a maximum, a sum, a difference, a multiplication, a division, a transformation, or any combination thereof.

### Configuration Example

In accordance with embodiments, a configuration for configuring the intermediate node 200 for an operation in the radio tag or A-IoT-STBY mode includes the following parameters
A time duration of the A-IoT-STBY mode.
A periodicity indicating how frequently the intermediate UE collects data.
A data retention time, i.e., for how long the data stored is valid, e.g., the UE goes out of coverage for a given amount of time without being able to retransmit the data. If the timer expires stored data is no longer valid, as it can be considered outdated.
Transition thresholds, which may define different thresholds or conditions under which the device transitions from RRC_INACTIVE to RRC_CONNECTED state, and vice versa.
An area where the configuration is valid.
A type of devices and/or a specific traffic type for which the configuration is valid.

An embodiment of an RRC configuration for the radio tag or A-IoT-STBY mode may be as follows:

AIoT-STBYConfig := SEQUENCE {

| | |
|---|---|
| AIoT-STBY-Duration | CHOICE (ms1, ms5, ms10, ms20, ms100, ms500, |

ms1000)

| | |
|---|---|
| AIoT-STBY-Periodicity | CHOICE (ms1, ms5, ms10, ms20, ms100, ms500, |
| ms1000) | OPTIONAL, |
| AIoT-STBY-Resources | CHOICE { |
| resourcePool | AIoT-STBY-Pool, |
| specificResources | AIoT-STBY-CG |

},

| | |
|---|---|
| AIoT-STBY-Transition-Th | AIoT-STBY-Th OPTIONAL, |
| AIoT-STBY-Data-Retention-Time | CHOICE (ms100, ms500, ms1000, ms5000, |

| | |
|---|---|
| ms10000) | OPTIONAL |

| | |
|---|---|
| AIoT-STBY-Groups | SEQUENCE (SIZE(1..maxAIoTGroups)) OF |

| | |
|---|---|
| AIoTGroups | OPTIONAL. |

}

### General

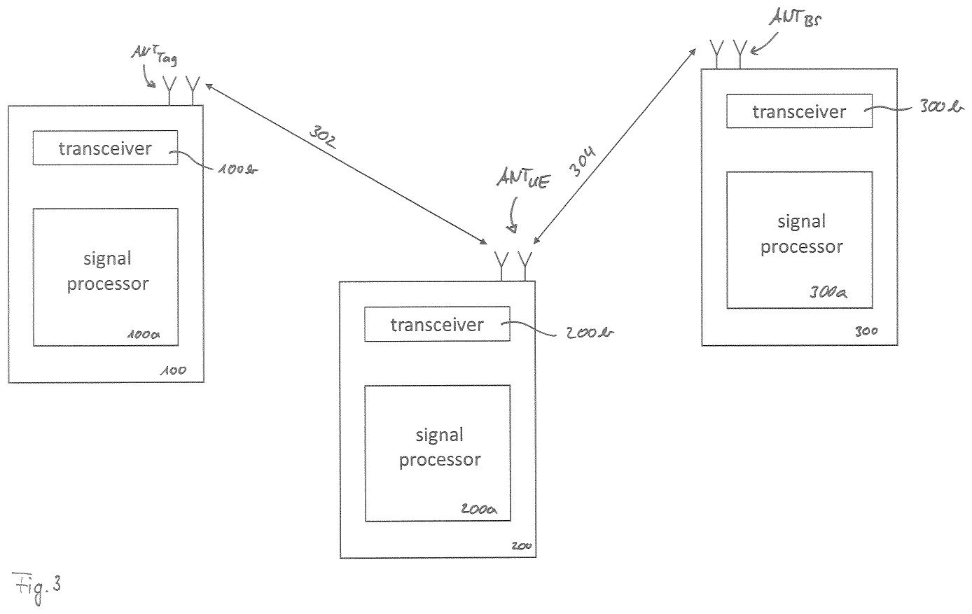

In the embodiments described above, reference has been made to a wireless communication system including, as illustrated in FIG. 3, the radio tag 100 and the reader device 200. In accordance with further embodiments, the wireless communication network may include a plurality of radio tags and a plurality of reader devices for addressing respective radio tags within their communication range.

In accordance with embodiments, the reader devices 200 may be network entities of a certain wireless communication system, for example a network entity of a 3GPP system or a WiFi system, like a user equipment or a relay node in the 3GPP system, or a WiFi station or access point in a WiFi system. In such embodiments, the radio devices may be addressed in accordance with the respective transmission protocol used by the wireless communication system, i.e., the radio devices may be directly addressed by the network entities of the respective wireless network.

In accordance with other embodiments, the reader tags, for example the above mentioned ultra-low complexity/ultra-low power consumption devices may not operate in accordance with the communication protocols as defined by a standard of the wireless communication network to which, for example, the reader device belongs, for example they may not operate fully in accordance with the 3GPP standard or the WiFi standard. Such radio devices, like ultra-low complexity/power ambient IoT devices, may only be addressable by appropriately adapted reader devices 200, like Ambient IoT readers or scanners. In accordance with such embodiments, the reader device 200 communicates with the respective radio devices using, for example, the ALOHA protocol, and acts as an intermediate or relay node or as a gateway node to the wireless communication system. For example the IDs of the radio devices may be translated into the International mobile subscriber identity, IMSI, and/or temporary mobile subscriber identity, TMSI. The IMSI is a unique identifier associated with a SIM card of a subscriber, while the TMSI is a temporary identifier that is used to provide a level of privacy and security by avoiding transmissions of the IMSI over the air interface. In a cellular network, these identifiers are used in the identification and communication with the UEs, and the reader device 200, as an intermediate node, translates the device-IDs of the radio tags 100 to respective identifiers being in conformity with the communication standard of the wireless communication system. Thus, the respective radio devices may also be addressed by network entities of the wireless communication network to which the reader device is connected, thereby integrating low complexity, low power radio devices into an existing wireless communication network, like the 3GPP network or the WiFi network.

In accordance with embodiments, the one or more reader devices 200 may be configured or preconfigured with a large number of virtual addresses, for example by using ESIM so that messages may be directly forwarded from and/or to an NG-RAN node or a core network, like 5GC.

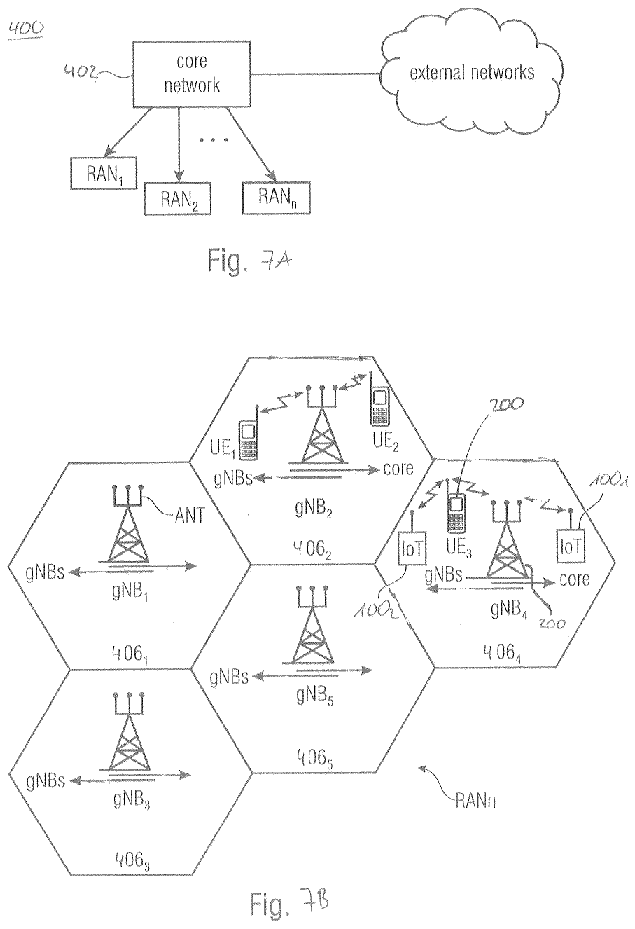

FIG. 7(A) and FIG. 7(B) schematically represent an example of a terrestrial 3GPP wireless network 400 including, as is shown in FIG. 7(A), the core network, CN, 402 and one or more radio access networks, RAN₁, RAN₂, . . . , RAN_{N}. FIG. 7(B) is a schematic representation of an example of a radio access network RANₙ including one or more base stations gNB1 to gNB5 each serving a specific area surrounding the base station as is schematically represented by the cells 4061 to 4065. The base stations are provided to serve users within a cell, for example, in the licensed and/or unlicensed bands. The term base station, BS, may refer to a gNB in 5G networks, an eNB in UMTS/LTE/LTE-A/LTE-APO or just a base station in other mobile communication standards, for example a base station in a 6G network. The BS may also comprise integrated access and backhaul, IAB, modes, e.g., an IAB donor and/or an IAB node consisting of a central unit, CU, as well as distributed units, DU. FIG. 7(B) further illustrates the IoT devices 1001, 1002 operating in accordance with the teachings of the present invention. The IoT device 1002 may be a radio device which is not addressable using the communication protocol of the wireless communication network depicted in FIG. 7(A) and FIG. 7(B). In such embodiments, UE3 acts as the reader device 200 used for addressing IoT device 1002. UE3 may act as the above described intermediate or relay node for a communication via the base station gNB4.

In accordance with embodiments the reader device 200 may also be a network entity of a 3GPP wireless communication network, like a base station or a gNB depicted in FIG. 7(B). For example, the reader device may be part of the gNB4 which is a node providing NR user plane and control plane protocol terminations towards a UE, and is connected via the NG interface to the core network (5GC). The reader device for communicating with at least one radio tag of a plurality of radio tags, like the A-IoT devices 1001, 1002, is connected to the gNB of the RAN of the wireless communication network by deploying the reader device within the gNB. In accordance with embodiments, the reader device is referred to as a gNB-reader which is an A-IoT reader that is deployed within the gNB, and the plurality of radio tags are the A-IoT devices 1001, 1002. The 5GC may include an A-IoT CN node which is a core network node which the gNB connects to 5GC for A-IoT operation. More specifically, it is the Ambient IoT Function (AIoTF) in case the gNB directly connects with the AIoTF, and it includes both the AMF and AIoTF in case the gNB connects with the AIoTF via AMF.

An A-IoT radio interface provides the communication between the one or more A-IoT devices and the A-IoT reader or gNB-reader. The A-IoT radio interface supports one or more A-IoT procedures, e.g., an inventory or a command procedure, and an A-IoT device monitors an R2D message as long as it has sufficient energy.

Responsive to one or more conditions, the reader device operates in accordance with the A-IoT radio interface for enabling the data transfer between the one or more A-IoT devices and the A-IoT reader (gNB reader).

In accordance with embodiments, the condition for operating in accordance with the A-IoT radio interface may be a certain communication with the at least one radio tag or A-IoT device, like an A-IoT paging, an A-IoT access procedure and a D2R data transmission performed, e.g., during an inventory or a command procedure indicating the one or more A-IoT devices which are targeted for the inventory or the command procedure by an A-IoT device identification requested.

In accordance with other embodiments, the condition for operating in accordance with the A-IoT radio interface may be a certain radio tag operation to be performed by the reader device, e.g., an inventory procedure or a routinary inventory scan or a command procedure, through the plurality of radio tags (A-IoT devices) to be performed over the A-IoT radio interface which includes an A-IoT paging, an A-IoT access procedure and a D2R data transmission and indicates the one or more A-IoT devices which are targeted for the inventory or the command procedure by an A-IoT device identification requested.

In accordance with yet other embodiments, the condition for operating in accordance with the A-IoT radio interface may be a certain signaling from a network entity, like an inventory or a command request message sent by the A-IoT CN node for initiating the inventory or the command procedure over the A-IoT radio interface to perform an A-IoT paging, an A-IoT access procedure and a D2R data transmission. The inventory request message also includes an A-IoT device identification requested corresponding to the one or more A-IoT devices which are targeted for the inventory or the command procedure.

In accordance with embodiments, the D2R data transmission may implement a D2R segmentation for receiving only a first part of a data transmission from the at least one radio tag which indicates, e.g., a second part of a data transmission. In accordance with embodiments, for implementing the D2R segmentation, the A-IoT device, e.g., using its MAC entity,
generates a D2R upper layer data transfer message for the first part of a data transmission (segment) which includes a SDU length field and a data SDU field which is set to include the segment (data transmission). Stated differently, the D2R data transmission from the radio tag (A-IoT device) may indicate explicitly a size of the data transmission, and
instructs the physical layer to transmit the D2R upper layer data transfer message.

If the segment is the last segment of the original upper layer data SDU, a more data indication field is set to 0. Stated differently, the D2R data transmission from the radio tag (A-IoT device) may indicate explicitly a last part of the data transmission.

If the segment is not the last segment of the original upper layer data SDU, the more data indication field is set to 1. Stated differently, the D2R data transmission from the radio tag (A-IoT device) may indicate explicitly a further part of the data transmission. The D2R data transmission may be determined to be the initial part of the data transmission from the presence of the signaling (more data indication field is set to 1) in the initial part of the data transmission indicating the presence of one or more additional parts of the data transmission.

In accordance with other embodiments, the wireless communication network may be a WiFi network and the illustrated elements may be WiFi elements, for example the base stations illustrated may refer to an access point, AP, in any one of the WiFi standards belonging, for example, to the IEEE 802.11-family.

Although the respective aspects and embodiments of the inventive approach have been described separately, it is noted that each of the aspects/embodiments may be implemented independent from the other, or some or all of the aspects/embodiments may be combined.

In accordance with embodiments of the present invention, a user device comprises one or more of the following: a power-limited UE, or a hand-held UE, like a UE used by a pedestrian, and referred to as a Vulnerable Road User, VRU, or a Pedestrian UE, P-UE, or an on-body or hand-held UE used by public safety personnel and first responders, and referred to as Public safety UE, PS-UE, or an IoT UE, e.g., a sensor, an actuator or a UE provided in a campus network to carry out repetitive tasks and requiring input from a gateway node at periodic intervals, a mobile terminal, or a stationary terminal, or a cellular IoT-UE, or a vehicular UE, or a vehicular group leader (GL) UE, or a sidelink relay, or an IoT or narrowband IoT, NB-IoT, device, or wearable device, like a smartwatch, or a fitness tracker, or smart glasses, or a ground based vehicle, or an aerial vehicle, or a drone, or a moving base station, or road side unit (RSU), or a building, or any other item or device provided with network connectivity enabling the item/device to communicate using the wireless communication network, e.g., a sensor or actuator, or any other item or device provided with network connectivity enabling the item/device to communicate using a sidelink the wireless communication network, e.g., a sensor or actuator, or any sidelink capable network entity.

In accordance with embodiments of the present invention, a RAN network entity, like the base station or gNB, comprises one or more of the following: a macro cell base station, or a small cell base station, or a central unit of a base station, or a distributed unit of a base station, or a road side unit (RSU), or a remote radio head, or an AMF, or an MME, or an SMF, or a core network entity, or mobile edge computing (MEC) entity, or a network slice as in the NR or 5G core context, or any transmission/reception point, TRP, enabling an item or a device to communicate using the wireless communication network, the item or device being provided with network connectivity to communicate using the wireless communication network.

Although some aspects of the described concept have been described in the context of an apparatus, it is clear that these aspects also represent a description of the corresponding method, where a block or a device corresponds to a method step or a feature of a method step. Analogously, aspects described in the context of a method step also represent a description of a corresponding block or item or feature of a corresponding apparatus.

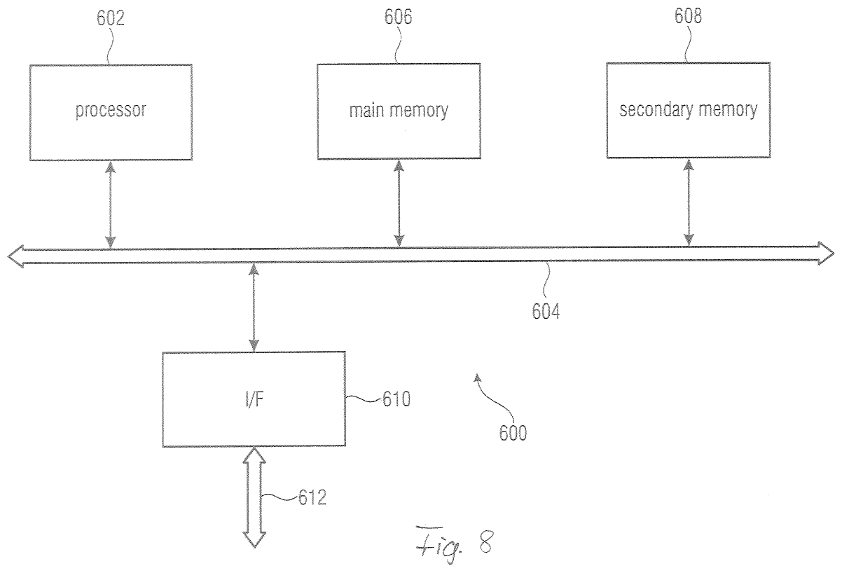

Various elements and features of the present invention may be implemented in hardware using analog and/or digital circuits, in software, through the execution of instructions by one or more general purpose or special-purpose processors, or as a combination of hardware and software. For example, embodiments of the present invention may be implemented in the environment of a computer system or another processing system. FIG. 8 illustrates an example of a computer system 600. The units or modules as well as the steps of the methods performed by these units may execute on one or more computer systems 600. The computer system 600 includes one or more processors 602, like a special purpose or a general-purpose digital signal processor. The processor 602 is connected to a communication infrastructure 604, like a bus or a network. The computer system 600 includes a main memory 606, e.g., a random-access memory, RAM, and a secondary memory 608, e.g., a hard disk drive and/or a removable storage drive. The secondary memory 608 may allow computer programs or other instructions to be loaded into the computer system 600. The computer system 600 may further include a communications interface 610 to allow software and data to be transferred between computer system 600 and external devices. The communication may be in the from electronic, electromagnetic, optical, or other signals capable of being handled by a communications interface. The communication may use a wire or a cable, fiber optics, a phone line, a cellular phone link, an RF link and other communications channels 612.

The terms “computer program medium” and “computer readable medium” are used to generally refer to tangible storage media such as removable storage units or a hard disk installed in a hard disk drive. These computer program products are means for providing software to the computer system 600. The computer programs, also referred to as computer control logic, are stored in main memory 606 and/or secondary memory 608. Computer programs may also be received via the communications interface 610. The computer program, when executed, enables the computer system 600 to implement the present invention. In particular, the computer program, when executed, enables processor 602 to implement the processes of the present invention, such as any of the methods described herein. Accordingly, such a computer program may represent a controller of the computer system 600. Where the disclosure is implemented using software, the software may be stored in a computer program product and loaded into computer system 600 using a removable storage drive, an interface, like communications interface 610.

The implementation in hardware or in software may be performed using a digital storage medium, for example cloud storage, a floppy disk, a DVD, a Blue-Ray, a CD, a ROM, a PROM, an EPROM, an EEPROM or a FLASH memory, having electronically readable control signals stored thereon, which cooperate or are capable of cooperating with a programmable computer system such that the respective method is performed. Therefore, the digital storage medium may be computer readable.

Some embodiments according to the invention comprise a data carrier having electronically readable control signals, which are capable of cooperating with a programmable computer system, such that one of the methods described herein is performed.

Generally, embodiments of the present invention may be implemented as a computer program product with a program code, the program code being operative for performing one of the methods when the computer program product runs on a computer. The program code may for example be stored on a machine readable carrier.

Other embodiments comprise the computer program for performing one of the methods described herein, stored on a machine readable carrier. In other words, an embodiment of the inventive method is, therefore, a computer program having a program code for performing one of the methods described herein, when the computer program runs on a computer.

A further embodiment of the inventive methods is, therefore, a data carrier or a digital storage medium, or a computer-readable medium comprising, recorded thereon, the computer program for performing one of the methods described herein. A further embodiment of the inventive method is, therefore, a data stream or a sequence of signals representing the computer program for performing one of the methods described herein. The data stream or the sequence of signals may for example be configured to be transferred via a data communication connection, for example via the Internet. A further embodiment comprises a processing means, for example a computer, or a programmable logic device, configured to or adapted to perform one of the methods described herein. A further embodiment comprises a computer having installed thereon the computer program for performing one of the methods described herein.

In some embodiments, a programmable logic device, for example a field programmable gate array, may be used to perform some or all of the functionalities of the methods described herein. In some embodiments, a field programmable gate array may cooperate with a microprocessor in order to perform one of the methods described herein. Generally, the methods are preferably performed by any hardware apparatus.

While this invention has been described in terms of several embodiments, there are alterations, permutations, and equivalents which fall within the scope of this invention. It should also be noted that there are many alternative ways of implementing the methods and compositions of the present invention. It is therefore intended that the following appended claims be interpreted as including all such alterations, permutations and equivalents as fall within the true spirit and scope of the present invention.

I/We claim:

1. A reader device for communicating with at least one radio tag of a plurality of radio tags,
wherein the reader device is connectable to or is deployed within a radio access network, RAN, entity of a wireless communication system and to one or more or all of the plurality of radio tags,
wherein, responsive to one or more conditions, the reader device is to operate in accordance with a radio tag mode, e.g. an A-IoT mode, in which a data transfer between the radio device and the at least one radio tag is enabled.

2. The reader device of claim 1, wherein, for communicating with at least one radio tag of a plurality of radio tags, like one or more A-IoT devices, the reader device comprises a gNB-reader which is an A-IoT reader that is deployed within the RAN entity, like a gNB.

3. The reader device of claim 2, wherein the A-IoT reader deployed within the gNB communicates with the one or more A-IoT devices using an A-IoT radio interface, the A-IoT radio interface supporting one or more A-IoT procedures, the A-IoT procedure comprising an A-IoT paging, an A-IoT access procedure and a D2R data transmission performed during the A-IoT procedure.

4. The reader device of claim 3, wherein, responsive to the one or more conditions, the A-IoT reader operates in accordance with the A-IoT radio interface for enabling the data transfer between the one or more A-IoT devices and the A-IoT reader.

5. The reader device of claim 4, wherein the one or more conditions for operating in accordance with the A-IoT radio interface comprises a certain communication with the at least one radio tag or A-IoT device, like an A-IoT paging, an A-IoT access procedure and a D2R data transmission performed during the A-IoT procedure.

6. The reader device of claim 4, wherein the one or more conditions for operating in accordance with the A-IoT radio interface comprises an A-IoT procedure to be performed by the reader device over the A-IoT radio interface which includes an A-IoT paging, an A-IoT access procedure and a D2R data transmission.

7. The reader device of claim 4, wherein the one or more conditions for operating in accordance with the A-IoT radio interface comprises an inventory or command request message sent by an A-IoT CN node for initiating the A-IoT procedure over the A-IoT radio interface to perform an A-IoT paging, an A-IoT access procedure and a D2R data transmission.

8. The reader device of claim 4, wherein the reader device receives the D2R data transmission, the D2R transmission comprising a D2R upper layer data transfer message for a segment of the data transmission which includes
a SDU length field,
a data SDU field which is set to include the segment, and
a more data indication field.

9. The reader device of claim 8, wherein the more data indication field is set to
0, if the segment is the last segment of an original upper layer data SDU,
1, if the segment is not the last segment of the original upper layer data SDU.

10. The reader device of claim 1, wherein the one or more conditions comprise one or more of the following:
a certain communication with the at least one radio tag,
a certain radio tag operation to be performed by the reader device,
a certain signaling causing the reader device to operate according to the radio tag mode.

11. The reader device of claim 10, wherein the certain communication with the at least one radio tag comprises:
receiving only a first part of a data transmission from the at least one radio tag which indicates, e.g., a second part of a data transmission.

12. The reader device of claim 11, wherein a transmission from the at least one radio tag indicates explicitly one or more of the following:
a further part of the data transmission,
a last part of the data transmission,
a size of the data transmission.

13. The reader device of claim 12, wherein the reader device is to determine the transmission to be the initial part of the data transmission
from a presence of a signaling in the initial part of the data transmission indicating the presence of one or more additional parts of the data transmission.

14. The reader device of claim 5, wherein the certain radio tag operation to be performed by the reader device comprises:
one or more routinary inventory scans through the plurality of radio tags.

15. The reader device of claim 10, wherein the certain signaling is responsive to determining one of more of the following:
the certain communication with the at least one radio tag,
the certain radio tag operation to be performed by the reader device.

16. The reader device of claim 1, wherein, when operating in accordance with the radio tag mode, the reader device is to perform the following operation:
receiving and/or reading of data from the at least one radio tag.

17. The reader device of claim 1, wherein the reader device is to communicate with
a core network of the wireless communication system using a core interface, and
the radio tag using an A-IoT radio interface.

18. A radio tag for communicating with a reader device, which serves a plurality of radio tags and is gNB-reader comprising an A-IoT reader that is deployed within a gNB of a wireless communication system,
wherein the radio tag comprises an A-IoT device which communicates with the A-IoT reader using an A-IoT radio interface, the A-IoT radio interface supporting one or more A-IoT procedures, the A-IoT procedure comprising an A-IoT paging, an A-IoT access procedure and a D2R data transmission performed during the A-IoT procedure, and
wherein the D2R transmission by the radio tag comprises a D2R upper layer data transfer message for a segment of the data transmission which includes:
a SDU length field,
a data SDU field which is set to include the segment, and
a more data indication field, wherein the more data indication field is set to 0, if the segment is the last segment of an original upper layer data SDU, and wherein the more data indication field is set to 1, if the segment is not the last segment of the original upper layer data SDU.

19. A method for operating a reader device for communicating with at least one radio tag of a plurality of radio tags, wherein the reader device is connectable to or is deployed within a radio access network, RAN, entity of a wireless communication system and to one or more or all of the plurality of radio tags, the method comprising:
responsive to one or more conditions, operating the reader device in accordance with a radio tag mode, e.g. an A-IoT mode, in which a data transfer between the radio device and the at least one radio tag is enabled.
